(19) United States
(12) Patent Application Publication
(10) Pub. No.: US 2017/0086357 A1
(43) Pub. Date: Mar. 30, 2017

(54) SEED PLANTING AND METERING EQUIPMENT

(71) Applicant: Johannes De Buys Vivier, Hoopstad (ZA)

(72) Inventor: Johannes De Buys Vivier, Hoopstad (ZA)

(21) Appl. No.: 15/311,175

(22) PCT Filed: May 13, 2015
(86) PCT No.: PCT/IB2015/053531

§ 371 Date: Nov. 14, 2016

(30) Foreign Application Priority Data
May 14, 2014 (ZA) ZA2014/03480

(51) Int. Cl. A01C 7/10; A01C 7/04; A01C 7/20; A01C 5/06

(52) U.S. Cl. CPC A01C 7/102; A01C 5/064; A01C 7/046; A01C 7/206; A01C 5/068

(57) ABSTRACT

The invention provides a row planting unit for a planter having a seed tube with an outlet arranged to drop seed between a pair of opener discs. Adjacent planting units (on the planter) each have vacuum operated seed metering units each including a seed disk. The operation of disks is synchronized but the seed openings offset from each other for alternate seed placement in adjacent rows. The outlet of each seed tube is located between the discs and, more specifically, arranged to drop seed in close proximity to a drop location where the bottom edges of the disks are in contact. The invention extends to a method of planting seed in a close staggered planting configuration, with seeds in adjacent rows dropped alternately and the row planting units located on the planter with closer spacing than what is used when seeds are planted substantially in line by adjacent row units.

### FIELD OF THE INVENTION

The invention relates to equipment used to plant seeds and also for the metering of seeds for a regular, spaced apart planting pattern. The invention is implemented on a row planting unit of the kind used in varying numbers on a planter drawn by a tractor.

### BACKGROUND TO THE INVENTION

Planters of the kind referred to are well known and widely used. In particular, it is the arrangement of seed tubes and opener disks that the invention relates to. The invention extends to metering apparatus that deposit seeds into the top of the seed tubes at regular intervals.

It is these components that largely determine the position and spacing of seeds in the furrows made by the opener disks and then closed by closing wheels.

### OBJECT OF THE INVENTION

It is an object of the invention to provide equipment which will allow for the placement of seeds at a desirable and regular spacing along planting rows. It is a further object of the invention to provide for the placement of seed in a manner that effectively utilizes the planting area of a selected piece of land.

### SUMMARY OF THE INVENTION

In accordance with the invention there is provided a row planting unit for a planter which includes a pair of ground engaging, inclined opener disks rotatably supported with converging bottom edges and a seed tube with an outlet arranged to drop seed between the opener discs.

The invention further provides for the seed tube to be configured to have a substantially operatively forwardly disposed outlet with a leading section adjacent the outlet to direct a falling seed through the outlet; for the seed tube to be curved and/or inclined operatively forwardly adjacent the outlet from the tube; and for the outlet to be arranged to drop seed in close proximity to a drop location where the bottom edges of the disks are in contact.

Further features of the invention provide for the drop location to be provided from a point substantially operatively below axes of the disks and to a trailing side of the point; and for the point to correspond substantially to a central contact point between the opener disks.

Further features of the invention provide for the seed tube opening to be located between the opener disks; and for the seed tube to extend past an operatively rear side of axes of the opener disks.

In accordance with another aspect of the invention there is provided a pair of vacuum operated seed metering units for use on a pair of adjacent row planting units for a planter, each metering unit including a seed disk with spaced apart seed collection openings arranged inwardly of its periphery, the disks connected to a drive mechanism for synchronized rotation and the two disks having seed openings offset from each other for alternate seed placement in adjacent rows.

The invention further provides for the metering units to be provided on a pair of adjacent row planting units having closer spacing between the row units than what is used where metering units are provided for synchronized seed placement; and for the row units to be as defined above.

In accordance with another aspect of the invention there is provided a method of planting seed comprising using a plurality of row planting units connected to and drawn behind a planter and alternating the dropping of seeds in adjacent row units to provide a close staggered planting configuration

The invention further provides for the row planting units to be located on the planter with closer spacing between adjacent row units than what is used when seeds are planted substantially in line by adjacent row units; for the seeds to be dropped using metering units as defined above; and for the planting units as defined above to be used.

In accordance with another aspect of the invention there is provides a seed tube for a row planting unit that includes a pair of ground engaging, inclined opener disks rotatably supported with converging bottom edges, the seed tube configured to feed seed through an outlet arranged to drop seed between the opener discs.

The invention further provides for the seed tube to be configured to have a substantially operatively forwardly disposed outlet with a leading section adjacent the outlet to direct a falling seed through the outlet; and for the seed tube to be is curved and/or inclined operatively forwardly adjacent the outlet from the tube.

Further features of the invention provide for the outlet to be arranged to drop seed in close proximity to a drop location where the bottom edges of the disks are in contact; for the drop location to be provided from a point substantially operatively below axes of the disks and to an operatively trailing side of the point; and for the point to correspond substantially to a central contact point between the opener disks.

Further features of the invention provide for the seed tube to be configured for the seed tube opening to be located between the opener disks; and configured to extend past an operatively rear side of axes of the opener disks.

In accordance with another aspect of the invention there is provided a pair of seed discs for use in a pair of vacuum operated seed metering units on a pair of adjacent row planting units, each seed disk having spaced apart seed collection openings arranged inwardly of its periphery, connecteable to a drive mechanism for synchronized rotation and having seed openings offset from each other for alternate seed placement in adjacent rows.

### BRIEF DESCRIPTION OF THE DRAWINGS

These and other features of the invention will become more apparent from the following description of embodiments, made by way of example only, with reference to the accompanying drawings, in which:

FIG. 1 shows a side view of a row unit of the kind used behind a planter;

FIG. 2 shows a first side of pair of seed discs for vacuum metering units; and

FIG. 3 shows a second side of the pair of seed discs in FIG. 2.

### DETAILED DESCRIPTION OF THE INVENTION

The invention will be described with respect to embodiments that take the form of modifications to a John Deere planter and more specifically to row units and vacuum metering units of such a planter.

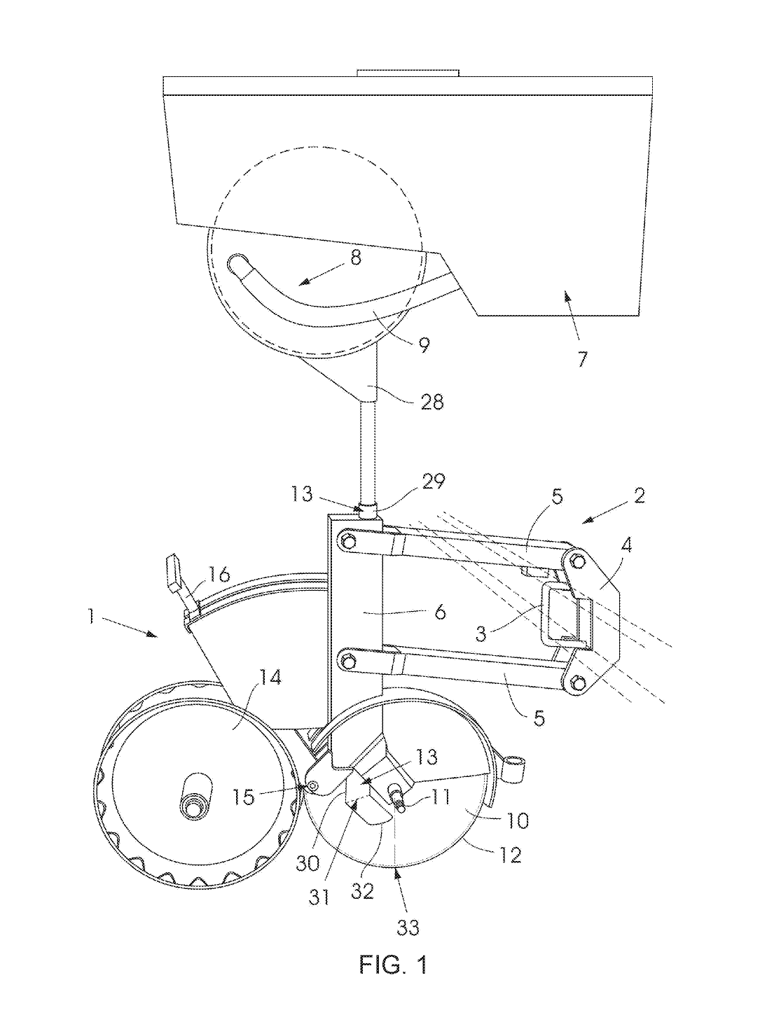

Referring to FIG. 1, a row unit (1) in accordance with the invention is provided with a frame (2). The frames (2) of a number of such units (1) will be connected in parallel arrangement extending to an operatively rear side of a wheeled chassis of a planter (not shown).

The connection to the chassis is made by way of U-clamps (3) through a mounting plate (4) at a front end of the frame (2). The frame (2) is pivotable relative to the mounting plate (4) through a pair of hingeable arms (5) that secured to a post (6).

A seed hopper (7) will be mounted above the frame (2) with a metering unit (8) beneath the hopper (7). The hopper (7) is connected to the seed metering unit (8) via a filling conduit (not shown). The metering unit (8) is connect to a vacuum pump via tube (9).

The post (6) of the frame (2) is connected to a pair of inclined opener disks (10) arranged in the usual manner providing a furrow-forming V-shaped configuration. The opener disks (10) are rotatably supported on downwardly inclined axles (11) with converging bottom edges (12) which engage along a limited region of contact. Only one of these disks (10) is shown in FIG. 1. The other disk (10) has been removed to show the lower portion of a seed tube (13) which extends from the metering unit (8).

To the rear of the opener disks (10) is a pair of closing wheels (14). The frame (2) includes a pivoting connection (15) for adjustment of the elevation of the opener disks (10) relative to the trailing closing wheels (14) and the chassis behind which the unit (1) is drawn to create a trench or furrow of a depth suited to the seed being planted. The adjustment is made using a handle (16).

A gearing assembly (not shown) is connected between the wheels of the planter and drive shafts (not shown) that respectively extend through and rotate seed disks (17) and (18) in the respective metering units (8). In this manner, the rate at which seed is discharged from the seed tubes (13) is coordinated to the ground speed of the planter.

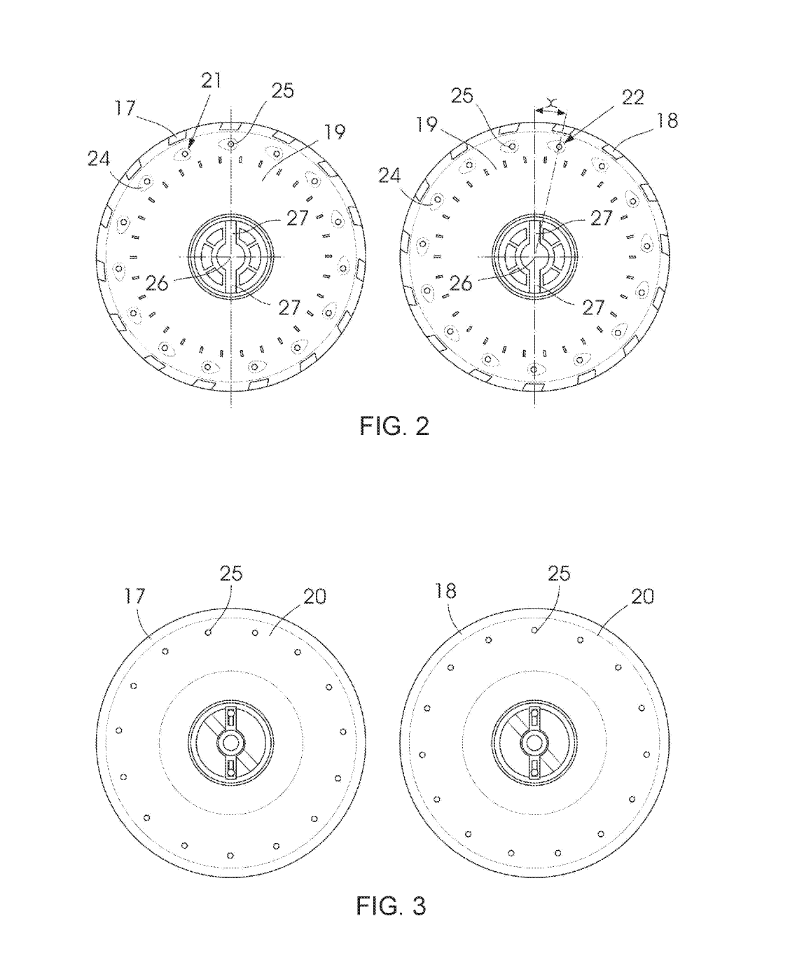

The two seed disks (17) and (18) shown in FIGS. 2 and 3 are provided in accordance with the invention for use on an adjacent pair of metering units (8).

Each seed disk (17) and (18) has a circular body with first (19) and second (20) sides having oppositely facing planar surfaces. A circular arrangement of spaced apart seed holes (21) and (22) extend transversely through the disk (17) and (18). The arrangement of holes (21) and (22) is provided spaced inwardly from a periphery (23) of the disk.

Each seed hole (21) and (22) has a curved wall recess or indentation (24) to receive a single grain of corn or maize on the first side (19) and an aperture (25) from the recess (24) through to the second side (20) for communication of the air pressure differential created by the vacuum.

A profiled opening (26) centrally located in each disk (17) and (18) is engageable onto the drive shaft. A pair of radial slots (27) in the central opening (26) respectively receive a pair of corresponding lugs (not shown) provided on a hub secured to the drive shaft. The seed holes (21) and (22) are offset from each other relative to radial slots (27) of the openings (26). The offset is indicated by “x”. The hub and slot (27) arrangement allows for fixed placement of seed holes (21) and (22) of the disk (17) and (18) relative to the drive shafts within a housing of the metering unit (8).

The holes (21) and (22) in disks (17) and (18) of metering units (8) on adjacent row units (1) will as a result drop seed alternately, at a different times, in the manner described below.

The housing of the metering unit (8) is bisected or divided by the disk (17; 18). To the first side (19) of the disk (17; 18) the housing receives seed from the hopper (7) via the filling conduit (not shown). This side is separated by a dense row of brush bristles (not shown). The bristles extend from a wall of the housing to engage against the surface on the first side (19) of the disk (17; 18) and separate the seed mass (which is filled to a controlled level) from an outlet or discharge chute (28) which feeds the seed tube (13). A gap at the top of the bristles allows for passage of seed bearing holes (21; 22) in the disk (17; 18) from the mass to the discharge chute (28).

The housing to the opposite, second side (20) of the disk (17; 18) is connected to the vacuum tube (9). This side of the housing is partitioned to create a region where the disk is not exposed to the vacuum and a vacuum chamber. This (substantially) ambient pressure region is isolated by a sealing member which extends between the vacuum chamber and the rotating disk (17; 18). This region corresponds to a position above the seed discharge chute (on the first side of the disk) and includes a seed knockout assembly comprising a wheel with prongs that run in the seed holes (21; 22) as the disk rotates. It is in this region that the seeds are dropped from the seed holes (21; 22) and deposited in the chute (28) by the disk (17; 18).

The vacuum in the chamber draws air through the plurality of holes (21; 22) of the seed disk (except for those holes transiently positioned beyond the sealing member of the vacuum chamber). As the disk (17; 18) rotates through the mass of seeds, each hole (21; 22) collects one seed under the effect of the pressure differential caused by the vacuum. As the seed disk (17; 18) continues to rotate the singulated seeds in the holes (21; 22) are moved through the gap past the top of the brush to a position over the seed discharge chute (28). As each of the singulated seeds is moved over the seed chute (28) the aperture (25) of the associated hole (21; 22) on the second side (20) of the seed disk (17; 18) crosses the vacuum barrier formed by the sealing member. The pressure differential is broken and the seed holes (21; 22) are moved past the knock-out member thereby releasing the seed from the first side (19) of the disk (17; 18). The seeds then sequentially fall away from the seed disk (17; 18) through the discharge chute (28) and into the seed tube (13).

The seed tube (13) extends from the metering unit (8) to a position between the opener disks (10). In use, individual seeds from the metering unit (8) are directed into the seed tube (13) and deposited into the furrow. The closing wheels (14) close the furrow, thereby planting the seed.

The seed tube (13) is an elongate tubular member. An upper substantially vertical portion of the tube (13) extends inside the post (6) of the frame (2). A top end (29) of the upper portion is connected to the discharge chute (28). A lower portion (30) of the tube (13), which protrudes from the bottom of the post (6) consists of opposing sidewalls and leading and trailing walls. The sidewalls are substantially flat and the leading and trailing walls rounded.

The seed tube (13) extends along a rear side of axes of the opener disks (10), where the discs (10) are connected to the axles (11). The leading wall and trailing wall are curved at (31) and forwardly inclined towards a bottom end of the tube (13), providing a forwardly disposed outlet (32).

The arrangement and configuration of the tube (13) provides for seed to be dropped from the outlet (32) along a forward trajectory between the opener discs (10) and to land in close proximity to a drop location where the bottom edges of the disks are closest to each other and thus in contact.

The drop location for the seed is preferably provided in a region extending from a point (33) substantially operatively below axles (11) of the opener disks (10) and to a trailing side of the point (33). The point (33) will in use correspond substantially to a central contact point between the opener disks (10).

It has been found that this trajectory and/or drop location of the seed provides for accurate and regular placement of the seed into the furrow. The opener disks (10) are turning forward and the seed is apparently put-down behind the contact region between the disks as the disks (10) move apart or as their turning edges separate.

In accordance with the invention there is also provided for the vacuum operated seed metering units (8) on adjacent row units (1), to include seed disks (17; 18) with the seed openings offset from each other. The arrangement is shown in the two discs of FIG. 2 and will be understood to provide for alternate seed placement in adjacent rows. The offset of the seed holes (21; 22) will determine that seeds on the adjacent discs (17; 18) will be released at different times in an alternating (substantially) regular manner. Seeds from the discs (17; 18) of every second metering unit (8) will however be released at the same time.

When the planter operates properly, the spacing between planted seed will be provided as desired and determined by the setting or calibration of the metering units (8). This spacing will be substantially equal (at least to a suitable degree) and staggered in the adjacent rows as a result of the offset holes (21; 22) as described.

This staggered placement of seeds in adjacent rows allows for closer spacing to be provided between the rows. The adjacent row units (1) will accordingly be mounted in closer proximity to each other than what is used where metering units are provided for synchronized seed placement at corresponding positions along the rows.

In this example, the four row units (1) will be provided between wheels on the planter chassis each with a space of about 300 mm between the respective opener discs (10). The 300 mm row spacing has been selected for planting peanuts.

The staggered planting configuration and spacing can however be varied for planting of any other seeds.

The closer spacing of the rows with offset positioning of the plants enables efficient use of planting land and serves to maximize yield from a particular size of land. The staggered planting configuration thus provides for less wasted space. The plants are provided with the required or desirable surrounding area or diameter of soil to grow and it has also been found that there is less open space between the plants for weed development.

It will be understood that the invention may be applied to seed disks suited to different seeds. They may be of a different thickness and have different configurations and spacing of holes as is intended for a different size and shape of seed. The seed disks shown in the drawings are of the flat-type. Some seed disks may have contoured pockets with raised outer boundaries that surround the openings for the vacuum holes.

There are also different configurations of row units with double opener disks. Some of these include gauge wheels and single cutting coulters, for example. The invention will also find application on these and other variations of the equipment.

While the seed tube (13) of the illustrated row unit (1) is made integral with the frame (2), it will be appreciated that the invention can equally be applied to a seed tube of the kind made as a separate component (commonly made from plastics material) which depends from a metering unit. Such seed tubes are, for example, made by John Deere but unlike the tube of the invention are curved rearwardly adjacent the outlet and drop the seed in the furrow behind the opener disks.

The invention extends to a method of planting seed using a plurality of row planting units having closer spacing between the row units than what is used when seeds are planted substantially in line by adjacent row units and alternating the dropping of seeds in adjacent row units to provide a close staggered planting configuration. The seeds will preferably be dropped or placed using metering units and planting units in accordance with the embodiments described above.

A person skilled in the art will appreciate that a number of changes can be made to the features of the embodiment described without departing from the scope of the invention.

1. A row planting unit for a planter which includes a pair of ground engaging, inclined opener disks rotatably supported with converging bottom edges and a seed tube with an outlet arranged to drop seed between the opener discs, in which the seed tube is curved and/or inclined operatively forwardly adjacent the outlet from the tube.

2-3. (canceled)

4. A planting unit as claimed in claim 1 in which the outlet is arranged to drop seed in close proximity to a drop location where the bottom edges of the disks are in contact.

5. A planting unit as claimed in claim 2 to in which the drop location is provided from a point substantially operatively below axes of the disks and to an operatively trailing side of the point.

6. A planting unit as claimed in claim 3 in which the point corresponds substantially to a central contact point between the opener disks.

7. (canceled)

8. A planting unit as claimed claim 1 in which the seed tube extends past an operatively rear side of axes of the opener disks.

9. A pair of vacuum operated seed metering units for use on a pair of adjacent row planting units as claimed in claim 1 for a planter, each metering unit including a seed disk with spaced apart seed collection openings arranged inwardly of its periphery, the disks connected to a drive mechanism for synchronized rotation and the two disks having seed openings offset from each other for alternate seed placement in adjacent rows.

10. The metering units as claimed in claim 6 provided on a pair of adjacent row planting units having closer spacing between the row units than what is used where metering units are provided for synchronized seed placement.

11-15. (canceled)

16. A seed tube for a row planting unit that includes a pair of ground engaging, inclined opener disks rotatably supported with converging bottom edges, the seed tube configured to feed seed through an outlet arranged to drop seed between the opener discs, in which the seed tube is curved and/or inclined operatively forwardly adjacent the outlet from the tube.

17-18. (canceled)

19. A seed tube as claimed in claim 8 in which the outlet is arranged to drop seed in close proximity to a drop location where the bottom edges of the disks are in contact.

20. A seed tube as claimed in claim 9 in which the drop location is provided from a point substantially operatively below axes of the disks and to an operatively trailing side of the point.

21. A seed tube as claimed in claim 10 in which the point corresponds substantially to a central contact point between the opener disks.

22. (canceled)

23. A seed tube as claimed in claim 8 configured to extend past an operatively rear side of axes of the opener disks.

24. (canceled)
